(19) United States
(12) Patent Application Publication
(10) Pub. No.: US 2006/0274282 A1
(43) Pub. Date: Dec. 7, 2006

(54) Projector

(75) Inventors: Nien-Hui Hsu, Miao Li County (TW); Lu-Wen Chien, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/444,479

(22) Filed: Jun. 1, 2006

(30) Foreign Application Priority Data
Jun. 3, 2005 (TW) 94118451

(51) Int. Cl. G03B 21/16; G03B 21/18

(52) U.S. Cl. 353/61

(57) ABSTRACT

The present invention provides a projector comprising a vent device disposed in an opening of the case through which heat flow generated from the light device is transmitted out of the projector. The vent structure comprises a first vent structure and a second vent structure. The first vent structure and the second vent comprise a plurality first vanes and a plurality of second vanes respectively. The first vanes are extending horizontally and are spaced out a predetermined distance apart respectively. The second vanes are extending obliquely and are spaced out predetermined distance apart respectively. The first vent structure is disposed close to the exterior of the projector, and the second vent structure is disposed close to the interior of the projector.

### BACKGROUND OF THE INVENTION

(1) Field of the Invention

The invention relates to a projector, and more particularly to a vent structure of a projector.

(2) Description of the Related Art

Generally, lamps provide lights that a projector needs for projecting images, however, heat also comes along with the process of lighting, and hence a heat radiator is needed for exhausting heat flow out of the projector.

Please refer to FIG. 1, which shows a sectional view of a conventional projector 2. A heat radiator of the projector 2 comprises a fan 4 and a vent structure 6. The fan 4 is disposed interior of a backside of the projector 2 for generating air flow to cool a lamp 10, and the vent structure 6 is disposed within an opening of a case 8 of the projector 2. The opening is disposed on a front side of the projector. 2. The fan 4 blows the heat flow out of the projector 2 through the vent structure 6.

The vent structure 6 comprises a plurality of vanes 602, which extend along a horizontal direction and are spaced out a predetermined distance apart respectively.

However, the design of the vanes 602 achieves the maximal capacity of the heat flow, but has a rather bad light shielding effect. It means that a light leaking phenomenon is serious. A user can see internal elements, which disposed inside the casing 8, for example the lamp 10 and the fan 4, and lights from the lamp 10 through the vent structure 6 of the projector 2.

For overcoming the above-mentioned disadvantages, please refer to FIG. 2, which shows a sectional view of another conventional projector 20. A fan 24, a lamp 10 and a vent structure 26 are disposed similarly to the projector 2 in FIG. 1; setting ways of vanes 2602 are different between FIG. 1 and FIG. 2.

The vent structure 26 comprises a plurality of the vanes 2602, which are spaced out a predetermined distance apart respectively. The vanes 2602 are downwardly oblique disposed from the interior of the projector 20 to the exterior of the projector 20 to prevent from a light leaking phenomenon and to shield the internal elements.

The oblique setting way of the vanes 2602 may solve the disadvantages of the projector 2, however, the heat flow passing through the vanes 2602 blows directly to a surface of a table. The heat flow striking the table changes the direction of the heat flow to block a part of the heat flow venting. It results in the velocity of the heat flow retarding, and temperature of the table rising.

Therefore, the present invention discloses a projector, which may solve above-mentioned disadvantages of conventional projectors.

### SUMMARY OF THE INVENTION

The object of the present invention is to provide a projector, which comprises a vent device for preventing light leaking to shield the internal elements and to prevent heat flow from striking a table and rising the temperature of the table.

To achieve above-mentioned object, a projector according to one embodiment of the present invention comprises a case, a light device, a fan, and a vent device. The light device is disposed inside the case for generating a light. The vent device is disposed in an opening of the case. Heat generated from the light device is transmitted out of the projector by airflow produced from the fan through the opening in a predetermined horizontal direction. The vent device comprises a first vent structure and a second vent structure.

### BRIEF DESCRIPTION OF THE DRAWINGS

The present invention will now be specified with reference to its preferred embodiment illustrated in the drawings, in which

FIG. 1 shows a sectional view of a conventional projector;

FIG. 2 shows a sectional view of a conventional projector;

FIG. 3 shows a sectional view of a projector according to one embodiment of the present invention; and

FIG. 4 shows a schematic view of an oblique angle θ according to one embodiment of the present invention.

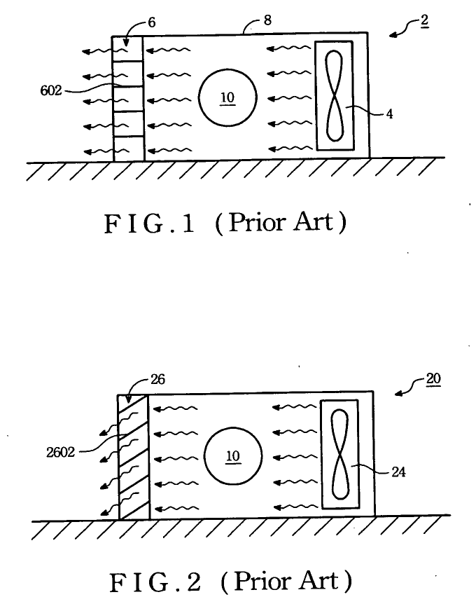

### DESCRIPTION OF THE PREFERRED EMBODIMENT

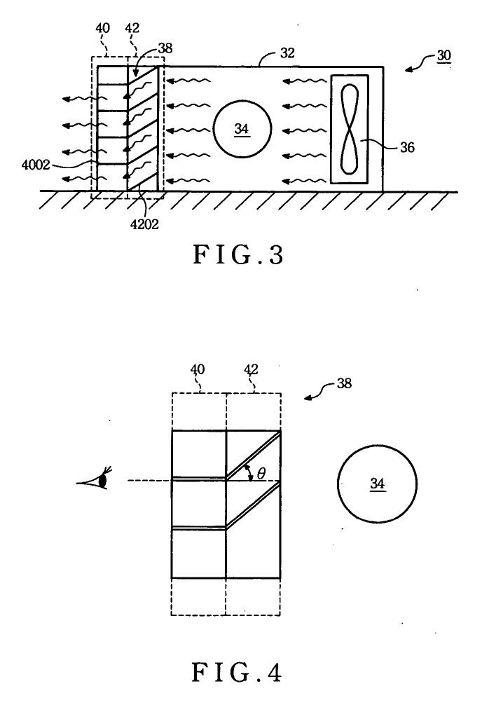

Please refer to FIG. 3, which shows a sectional view of a projector 30 according to one embodiment of the present invention. As shown, the projector 30 comprises a case 32, a light device 34, a fan 36 and a vent device 38. The light device 34 is disposed in the case 32 and comprises a lamp providing a light for the projector 30.

The fan 36 is disposed at the back side of the projector 30 for generating airflow, which transmits heat generated by the light device 34 outside the projector 30 through an opening disposed on the front side of the projector 30. The vent device 38 is disposed within the opening of the case 32. The heat generated by the light device passes through the vent device 38 in a predetermined horizontal direction.

The vent device 38 further comprises a first vent structure 40 and a second vent structure 42. The first vent structure 40 is disposed within the opening of the case 32 and is close to the exterior of the projector 30. The second vent structure 42 is disposed within the opening of the case 32 and is close to the interior of the projector 30. The second vent structure 42 and the first vent structure 40 are disposed side by side.

The first vent structure 40 comprises a plurality of first vanes 4002, and the second vent structure 42 comprises a plurality of second vanes 4202. A rear side of each first vane 4002 of the first vent structure 40 contacts a front side of each second vane 4202 of the second vent structure 42.

The first vanes 4002 are extending along a horizontal direction and are spaced out a predetermined distance apart respectively. The heat from the light device 34 is transmitted out of the projector 30 through the opening by the first vanes 4002. The second vanes 4202 are extending obliquely, and the second vanes 4202 are spaced out a predetermined distance apart respectively. Herein the second vanes 4202 are downwardly oblique disposed in a direction from the interior of the projector 30 to the exterior of the projector 30.

In this embodiment, the thickness of each of the first vanes 4002 is between 5 mm to 10 mm. Referring to FIG. 4, an oblique angle θ of the second vanes 42 to horizontal direction is between 30° to 60°, which can obtain a better effect for shielding the internal elements and anti-light leaking. Herein the oblique disposition of the second vane 4202 effectively shields internal elements and prevents from light leaking. Meanwhile, the horizontal first vanes 4002 lead the heat flow out of the projector 30 in a horizontal direction, which prevents the heat flow striking the table directly.

To sum up, the projector of the present invention provides the vent structure which comprising two kinds of vanes with different alignments. The design of two different aligning vanes could shield internal elements of the projector being seen from outside and prevent the problems of light leaking. Moreover, the projector of the present invention can also prevent the heat flow from striking the table directly.

While the present invention has been particularly shown and described with reference to a preferred embodiment, it will be understood by those skilled in the art that various changes in form and detail may be without departing from the spirit and scope of the present invention.

We claim:

1. A projector, comprises:
a case having an opening;
a light device disposed in the case generating lights for the projector; and
a vent device disposed within the opening of the case, and the vent device comprising:
a first vent structure, comprising a plurality of first vanes extending in a horizontal direction, the first vanes being spaced out a predetermined distance apart respectively,
a second vent structure, comprising a plurality of second vanes extending obliquely, the second vanes being spaced out a predetermined distance apart respectively,
wherein the first vent structure is disposed close to an exterior of the projector, and the second vent structure is disposed close to an interior of the projector, heat generated by the light device is transmitted out of the projector through the vent device.

2. The projector of claim 1, wherein a rear side of each first vane of the first vent structure contacts a front side of each second vane of the second vent structure.

3. The projector of claim 1, further comprising a fan generated air flow for blowing the heat generated by the light device out of the projector through the opening.

4. The projector of claim 1, wherein a thickness of each first vane is between 5 mm to 10 mm.

5. The projector of claim 1, wherein an oblique angle of each second vane to the horizontal direction is between 30° to 60°.

6. The projector of claim 1, wherein the first vent structure and the second vent structure are disposed side by side.
